(19) United States
(12) Patent Application Publication
(10) Pub. No.: US 2010/0281763 A1
(43) Pub. Date: Nov. 11, 2010

(54) Unit, Method, And Renewable Material

(75) Inventors: John W. Shabaker, Naperville, IL (US); Aaron Weiner, Aurora, IL (US); Douglass N. Rundell, Glen Ellyn, IL (US); Hensley Sejour, Chicago, IL (US); Gary Goeden, Batavia, IL (US)

Correspondence Address: CAROL WILSON;BP AMERICA INC., MAIL CODE 5 EAST, 4101 WINFIELD ROAD, WARRENVILLE, IL, 60555, US

(73) Assignee: BP Corporation North America Inc., Warrenville, IL (US)

(21) Appl. No.: 12/435,825

(22) Filed: May 5, 2009

(51) Int. Cl. C10L 1/185; B01J 8/04; B01J 10/00; B01D 17/00; C10L 1/182

(52) U.S. Cl. 44/448; 422/189; 422/149; 44/451; 44/447

(57) ABSTRACT

This invention relates to a unit, a method, and a renewable material. The unit for producing renewable materials includes a decarboxylation apparatus for converting a ketoacid stream into a ketone stream, and a hydrogenation apparatus for converting the ketone stream and a hydrogen stream into an alcohol stream. The method for producing renewable materials includes the step of converting a ketoacid stream into a ketone stream in a decarboxylation apparatus, and the step of converting the ketone stream and a hydrogen stream into an alcohol stream in a hydrogenation apparatus.

### BACKGROUND

1. Technical Field

This invention relates to a unit, a method, and a renewable material.

2. Discussion of Related Art

Tightening oil supplies and escalating energy prices along with environmental concerns over nonrenewable resources have prompted significant interest and research into renewable materials and/or biofuels. Efforts to reduce carbon emissions and greenhouse gases are also driving investment into renewable materials and/or biofuels.

Attempts are being made to produce renewable materials with biological processes. Biological processes may be costly and difficult to maintain operation of the living organisms. There is a need and a desire for robust chemical routes to renewable materials.

### SUMMARY

This invention relates to a unit, a method, and a renewable material, such as using a chemical route or path to renewable materials.

According to a first embodiment, this invention includes a unit for producing renewable materials. The unit includes a decarboxylation apparatus for converting a ketoacid stream into a ketone stream, and a hydrogenation apparatus for converting the ketone stream and a hydrogen stream into an alcohol stream.

According to a second embodiment, this invention includes a method for producing renewable materials. The method includes the step of converting a ketoacid stream into a ketone stream in a decarboxylation apparatus, and the step of converting the ketone stream and a hydrogen stream into an alcohol stream in a hydrogenation apparatus.

According to a third embodiment, this invention includes a renewable material made with and/or by the unit and/or the method described herein.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 illustrates a unit for producing renewable materials, according to one embodiment;

FIG. 2 illustrates a unit with a dehydration apparatus, according to one embodiment;

FIG. 3 illustrates a unit with a hydrolysis apparatus, according to one embodiment;

FIG. 4 illustrates a unit without an external hydrogen stream, according to one embodiment;

FIG. 5 illustrates a unit with a first separation apparatus and a second separation apparatus, according to one embodiment;

FIG. 6 illustrates a unit with a dewatering apparatus on an alcohol stream, according to one embodiment;

FIG. 7 illustrates a unit with an aldehyde apparatus, according to one embodiment;

FIG. 8 illustrates a unit with a dewatering apparatus on a ketoacid stream, according to one embodiment;

FIG. 9 illustrates a unit with a single reactor, according to one embodiment;

FIG. 10 illustrates a single reactor with multiple catalyst beds, according to one embodiment;

FIG. 11 illustrates a single reactor with a mixed catalyst bed, according to one embodiment;

FIG. 12 illustrates a single reactor with a multifunctional catalyst, according to one embodiment;

FIG. 13 illustrates a unit for producing renewable materials, according to one embodiment;

FIG. 14 illustrates a chemical reaction, according to one embodiment.

### DETAILED DESCRIPTION

This invention can relate to a unit, a method, and a renewable material. According to one embodiment, this invention may include a process for 2-butanol production from levulinic acid based on the acid-catalyzed degradation of cellulose. The 2-butanol desirably can be a renewable biofuel and/or a renewable chemical. The chemistry includes catalytic decarboxylation of levulinic acid to produce methyl ethyl ketone. The methyl ethyl ketone can be hydrogenated to form 2-butanol.

The process includes a combined decarboxylation of levulinic acid to methyl ethyl ketone and subsequent hydrogenation to 2-butanol, such as may be advantageous for the large scale, industrial production of 2-butanol.

Levulinic acid can be derived from any suitable source, such as from a cellulosic material. Levulinic acid has a molecular formula of C₅H₈O₃, a boiling point of 206 degrees Celsius, and a molar mass of 116 grams per mole.

Methyl ethyl ketone has a molecular formula of C₄H₈O, a boiling point of 79 degrees Celsius, and a molar mass of 72 grams per mole.

2-butanol has a molecular formula of C₄H₁₀O, a boiling point of 99 degrees Celsius, and a molar mass of 74 grams per mole.

Cellulosic material broadly refers to containing cellulose, such as plant material. Cellulosic material may include any suitable material or substance, such as sugar cane, sugar cane bagasse, energy cane bagasse, rice, rice straw, corn, corn stover, wheat, wheat straw, maize, maize stover, sorghum, sorghum stover, sweet sorghum, sweet sorghum stover, cotton, cotton remnant, sugar beet, sugar beet pulp, soybean, rapeseed, jatropha, switchgrass, miscanthus, other grasses, timber, softwood, hardwood, wood waste, sawdust, paper, paper waste, agricultural waste, municipal waste, any other suitable biomass material, and/or the like.

The decarboxylation may take place in a suitable reactor, such as a liquid-phase packed bed with copper faujasite (metal on zeolite) and/or similar catalyst. The decarboxylation reactor may operate at any suitable conditions, such as a temperature of at least about 20 degrees Celsius, at least about 100 degrees Celsius, at least about 300 degrees Celsius, at least about 500 degrees Celsius, and/or the like. The decarboxylation reactor may operate at a pressure of at least about 0 kilopascals gauge, at least about 200 kilopascals gauge, at least about 310 kilopascals gauge, and/or the like. The decarboxylation reaction can be mildly exothermic, such as with a heat of reaction of about −27 kilojoules per mole at 300 degrees Celsius. The decarboxylation reactor may be any suitable design, such as a packed bed, a slurry reactor, a fluidized bed, and/or the like.

The decarboxylation process may also include cooling the decarboxylation reactor effluent to a suitable temperature, such as between about 50 degree Celsius to about 300 degrees Celsius, between about 150 degrees Celsius to about 200 degrees Celsius, and/or the like. The decarboxylation process may also include a separation, such as in a flash drum and/or other suitable vessel. The flash drum may operate at any suitable pressure, such as at about 0 kilopascals gauge (atmospheric), at about 50 kilopascals, at about 150 kilopascals, and/or the like. Levulinic acid from a bottom of the flash drum can be pumped and/or circulated to the decarboxylation reactor as recycle. The methyl ethyl ketone vapor from the top of the flash drum can be condensed to a liquid, such as between about 50 degrees Celsius and about 80 degrees Celsius, and/or the like.

Carbon dioxide can be vented and/or flashed off in a second flash drum, for example. Carbon dioxide may be vented to the atmosphere, compressed for industrial purposes, sequestered using a suitable technique, and/or the like. The cooling steps may be accomplished by steam generation, using cooling water, feedstock heat integration, and/or the like.

The liquid methyl ethyl ketone intermediate stream can be pumped to any suitable pressure, such as between about 500 kilopascals and about 5000 kilopascals, between about 1375 kilopascals and about 3450 kilopascals, and/or the like. The liquid methyl ethyl ketone can be mixed with hydrogen gas and preheated to between about 50 degrees Celsius and about 400 degrees Celsius, between about 100 degrees Celsius and about 250 degrees Celsius, and/or the like.

The liquid methyl ethyl ketone can be supplied and/or fed to a hydrogenation reactor to form 2-butanol. The hydrogenation reactor may include any suitable design, such as a low-pressure trickle bed design (hydrotreater), a slurry continuous stirred tank reactor, and/or the like. The hydrogenation reactor may use any suitable catalyst, such as nickel based catalyst, ruthenium based catalyst, and/or the like. The hydrogenation reaction can be moderately exothermic, such as with a heat of reaction of about −69 kilojoules per mol at 25 degrees Celsius. The hydrogenation reactor may use cooling strategies, such as fluidized bed reactors, cooling coils, steam generation, and/or the like. The feed streams for the hydrogenation reaction may include any suitable concentration of reactants, such as feed streams with an about 1:1 molar ratio of hydrogen to methyl ethyl ketone, about as a 1:1 molar ratio of carbon dioxide to methyl ethyl ketone and 30 percent water, and/or the like.

The effluent from the hydrogenation reactor can be cooled to condense methyl ethyl ketone and/or 2-butanol. The reactor effluent including the condensed liquids can proceed into a flash drum (second flash drum), such as to vent any unconsumed hydrogen. The vented hydrogen can be compressed with a compressor and/to the like. The compressed hydrogen can be returned to the hydrogenation reactor for recycle, for example. The second flash drum and/or column can operate at any suitable pressure, such as about 0 kilopascals gauge (atmospheric), about 50 kilopascals, about 150 kilopascals, and/or the like.

An effluent from the hydrogenation reactor can include a mixture of methyl ethyl ketone and 2-butanol. The methyl ethyl ketone distillate can be condensed using cooling water and/or the like. The methyl ethyl ketone can be recycled to the hydrogenation reactor. The 2-butanol (bottoms) can be removed as final product.

In the alternative, the 2-butanol can be sent to a reactive distillation column and/or the like. The reactive distillation column can use a condensation reaction to form di-sec-butylether, for example. The process may desirably allow for product flexibility of renewable gasoline products and/or renewable diesel products.

Mixtures of methyl ethyl ketone and 2-butanol can be readily separated. Water, methyl ethyl ketone, and 2-butanol can form a ternary azeotrope which may use multiple columns to complete the desired separations. According to one embodiment, trace amounts of water produced by byproduct formation in the hydrogenation reactor may be removed prior to separations, such as by using molecular sieve drying. The byproduct reaction may include one unit of methyl ethyl ketone and two units of hydrogen converting to one unit of butane and one unit of water, for example (on a molar basis).

Hydrolysis of cellulose to form levulinic acid can also produce formic acid, such as in a 1:1 molar ratio and/or the like. Formic acid can decompose to form hydrogen and carbon dioxide thermally, catalytically, over metal catalysts, and/or the like. According to one embodiment, the decomposition of the formic acid can supply all of the hydrogen needed for subsequent hydrogenation of the methyl ethyl ketone. The formic acid may be fed to the decarboxylation reactor, the hydrogenation reactor, a feed preheater for either reactor, and/or the like. Feeding formic acid to the process can cause in-situ hydrogen production.

Feeding formic acid to the decarboxylation reactor may provide a reducing atmosphere. The hydrogen can be recovered from the carbon dioxide vent at the flash drum with suitable downstream processes.

To reduce operating costs and according to one embodiment, crude (less pure) levulinic acid may be used. The crude levulinic acid may include furfural and/or water. The crude levulinic acid may be available at advantageous cost relative to high-purity refined levulinic acid. Furfural in the crude levulinic acid may polymerize in the decarboxylation reactor and/or a feed preheater. The polymerization can be mitigated by adding a guard bed for furfural trapping or destroying it prior to heating to decarboxylation temperature.

In the alternative, the decarboxylation reactor can be a fluid bed, such as with a static design and/or a circulating design to avoid and/or reduce possible packed bed plugging issues from furfural.

Water in the levulinic acid feed may be removed by distillation, membrane separation, selective adsorption, molecular sieve drying, chemical drying (for example, magnesium sulfate), solvent extraction, and/or the like. Water in the levulinic acid feed may also greatly increase corrosion in the hydrogenation reaction. Enhanced metallurgy can be used to resist corrosion.

To reduce capital cost and according to one embodiment, the decarboxylation reactor and the hydrogenation reactor may be combined in a single pressure shell, such as with two catalyst beds at different temperatures, in two catalyst beds at a single temperature, in a single mixed catalyst bed, in a single bed with a multifunctional catalyst bed, and/or the like. The combined reactor design may be used with existing equipment, such as an unused naphtha hydrotreater. The single pressure shell design may include advanced control and/or operating strategies.

According to one embodiment, this invention can include a process for 2-butanol production (renewable biofuel and/or renewable chemical) from levulinic acid based acid-catalyzed degradation of cellulose. Levulinic acid can be decarboxylated to methyl ethyl ketone intermediate, which can be subsequently hydrogenated to form 2-butanol. The 2-butanol product may be used directly as a renewable chemical and/or a gasoline blendstock. In the alternative, the 2-butanol can be fed to another unit for subsequent processing, such as for condensation to di-sec-butyl ether or alkylation with olefins to make ethers. Di-sec-butyl ether and other ethers can be renewable chemicals and/or diesel blendstocks.

The scope of this invention may include additional embodiments, such as lower capital costs, lower operating costs, and/or upstream integration with the production of levulinic acid. These additional embodiments may include multipurpose catalysts and/or reactors, simplification of 2-butanol purification, use of lower cost crude levulinic acid feedstock (less pure), mitigation of corrosion issues, hydrogen recovery from decomposition of a formic acid byproduct, mitigation or use of the furfural byproduct, and/or the like.

According to one embodiment, this invention may include units and processes for producing renewable materials that exclude the use of biological routes, pathways, organisms, and/or the like.

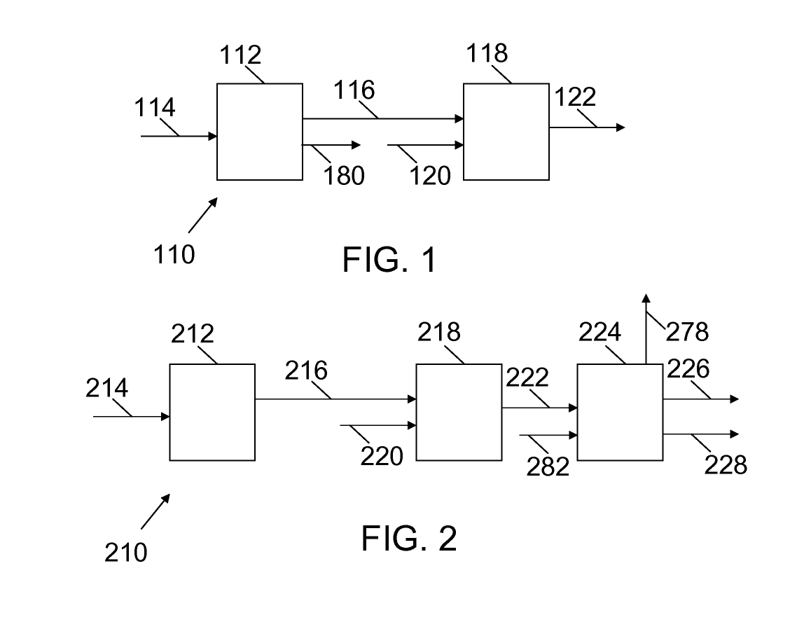

FIG. 1 illustrates a unit 110 for producing renewable materials, according to one embodiment. The unit 110 includes a decarboxylation apparatus 112 with a ketoacid stream 114 for an inlet, and a ketone stream 116 and optionally a ketone product stream 180 for outlets. The unit 110 also includes a hydrogenation apparatus 118 with the ketone stream 116 and a hydrogen stream 120 for inlets, and an alcohol stream 122 for an outlet.

FIG. 2 illustrates a unit 210 with a dehydration apparatus 224, according to one embodiment. The unit 210 includes a decarboxylation apparatus 212 with a ketoacid stream 214 for an inlet, and a ketone stream 216 for an outlet. The unit 210 also includes a hydrogenation apparatus 218 with the ketone stream 216 and a hydrogen stream 220 for inlets, and an alcohol stream 222 for an outlet. The unit 210 also includes a dehydration apparatus 224 with the alcohol stream 222 and optionally an olefin stream 282 for inlets, and a water stream 278, an ether stream 226 and/or an olefin stream 228 for outlets.

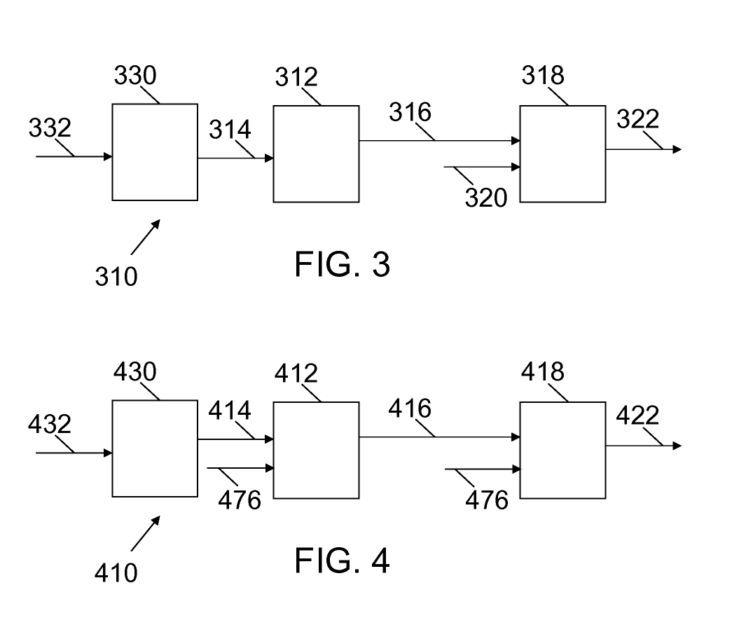

FIG. 3 illustrates a unit 310 with a hydrolysis apparatus 330, according to one embodiment. The unit 310 includes a decarboxylation apparatus 312 with a ketoacid stream 314 for an inlet, and a ketone stream 316 for an outlet. The unit 310 also includes a hydrogenation apparatus 318 with the ketone stream 316 and a hydrogen stream 320 for inlets, and an alcohol stream 322 for an outlet. The unit 310 also includes a hydrolysis apparatus 330 with a cellulose stream 332 for an inlet, and the ketoacid stream 314 as an outlet.

FIG. 4 illustrates a unit 410 without an external hydrogen stream, according to one embodiment. The unit 410 includes a decarboxylation apparatus 412 with a ketoacid stream 414 for an inlet, and a ketone stream 416 for an outlet. The unit 410 also includes a hydrogenation apparatus 418 with the ketone stream 416 for an inlet, where the needed hydrogen is generated in situ, and an alcohol stream 422 for an outlet. The unit 410 also includes a hydrolysis apparatus 430 with a cellulose stream 432 for an inlet, and the ketoacid stream 414 as an outlet. The hydrogen source may be a portion of the of the ketoacid stream 414 from the hydrolysis apparatus 430, such as formic acid. Optionally, the hydrogen source may be a hydrogen source stream 476, such as an inlet to the decarboxylation apparatus 412. Optionally, the hydrogen source may be a hydrogen source stream 476, such as an inlet to the hydrogenation apparatus 418.

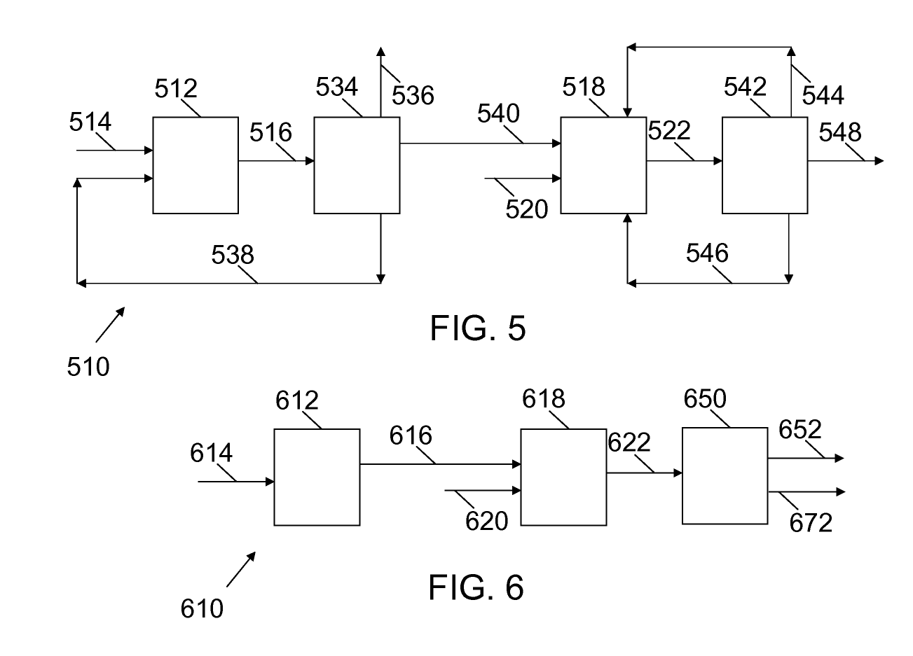

FIG. 5 illustrates a unit 510 with a first separation apparatus 534 and a second separation apparatus 542, according to one embodiment. The unit 510 includes a decarboxylation apparatus 512 with a ketoacid stream 514 and a recycle acid stream 538 for inlets, and a ketone stream 516 for an outlet. The unit 510 also includes the first separation apparatus 534 with the ketone stream 516 for an inlet, and a carbon dioxide stream 536, a recycle acid stream 538, and a first separation apparatus effluent stream 540 for outlets. The unit 510 also includes a hydrogenation apparatus 518 with the first separation effluent stream 540, a hydrogen stream 520, a recycle hydrogen stream 544, and a recycle ketone stream 546 for inlets, and an alcohol stream 522 for an outlet. The unit 510 also includes a second separation apparatus 542 with the alcohol stream 522 for an inlet, and the recycle hydrogen stream 544, the recycle ketone stream 546, and a product alcohol stream 548 for outlets.

FIG. 6 illustrates a unit 610 with a dewatering apparatus 650 on an alcohol stream 622, according to one embodiment. The unit 610 includes a decarboxylation apparatus 612 with a ketoacid stream 614 for an inlet, and a ketone stream 616 for an outlet. The unit 610 also includes a hydrogenation apparatus 618 with the ketone stream 616 and a hydrogen stream 620 for inlets, and an alcohol stream 622 for an outlet. The unit 610 also includes the dewatering apparatus 650 with the alcohol stream 622 for an inlet, and a dewatered alcohol stream 652 and a water stream 672 for outlets.

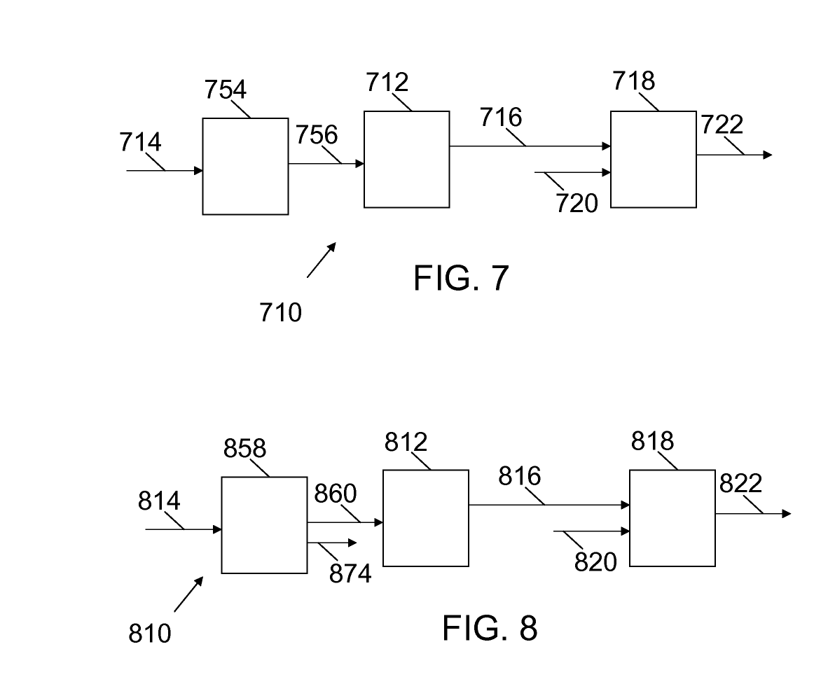

FIG. 7 illustrates a unit 710 with an aldehyde apparatus 754, according to one embodiment. The unit 710 includes the aldehyde apparatus 754 with a ketoacid stream 714 for an inlet, and a reduced aldehyde ketoacid stream 756 for an outlet. The unit 710 also includes a decarboxylation apparatus 712 with the reduced aldehyde ketoacid stream 756 for an inlet, and a ketone stream 716 for an outlet. The unit 710 also includes a hydrogenation apparatus 718 with the ketone stream 716 and a hydrogen stream 720 for inlets, and an alcohol stream 722 for an outlet.

FIG. 8 illustrates a unit 810 with a dewatering apparatus 858 on a ketoacid stream 814, according to one embodiment. The unit 810 includes the dewatering apparatus 858 with the ketoacid stream 814 for an inlet, and a dewatered ketoacid stream 860 and optionally a water stream 874 for outlets. The unit 810 also includes a decarboxylation apparatus 812 with the dewatered ketoacid stream 860 for an inlet, and a ketone stream 816 for an outlet. The unit 810 also includes a hydrogenation apparatus 818 with the ketone stream 816 and a hydrogen stream 820 for inlets, and an alcohol stream 822 for an outlet.

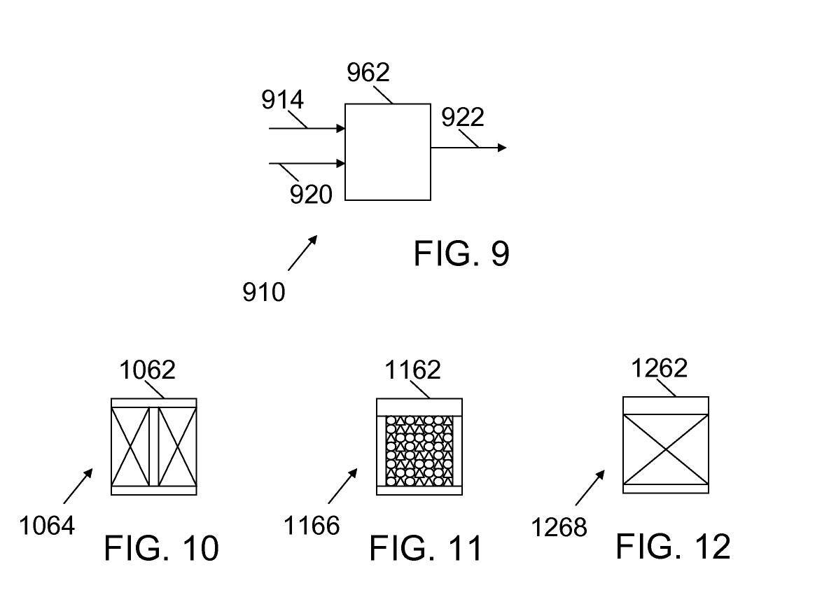

FIG. 9 illustrates a unit 910 with a single reactor 962, according to one embodiment. The single reactor 962 has a ketoacid stream 914 and a hydrogen stream 920 for inlets, and an alcohol stream 922 for an outlet.

FIG. 10 illustrates a single reactor 1062 with multiple catalyst beds 1064, according to one embodiment.

FIG. 11 illustrates a single reactor 1162 with a mixed catalyst bed 1166, according to one embodiment.

FIG. 12 illustrates a single reactor 1262 with a multifunctional catalyst 1268, according to one embodiment.

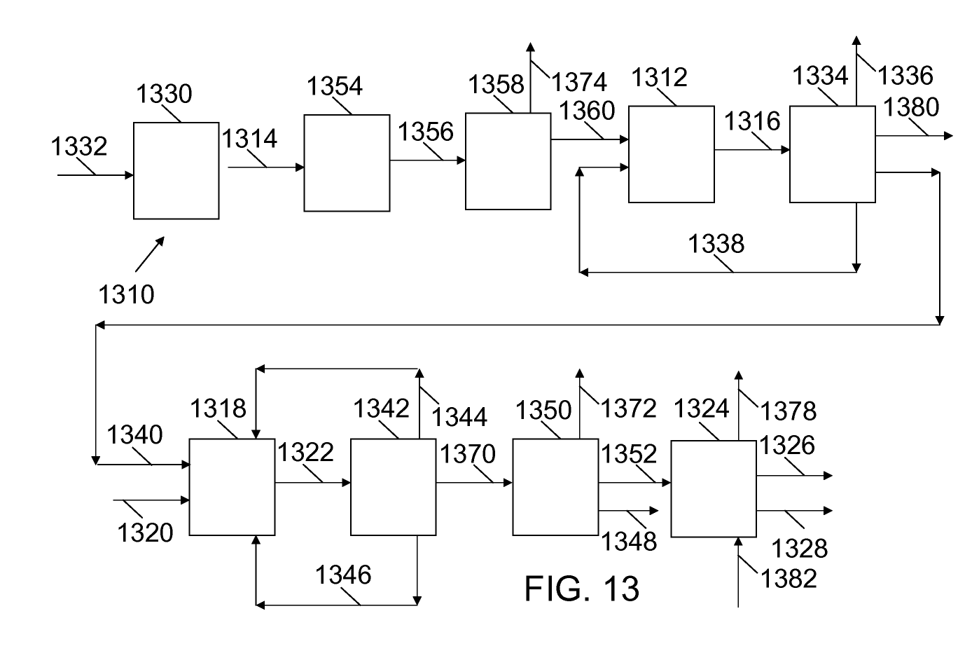

FIG. 13 illustrates a unit 1310 for producing renewable materials, according to one embodiment. The unit 1310 includes a hydrolysis apparatus 1330 with a cellulose stream 1332 for an inlet, and a ketoacid stream 1314 for an outlet. The unit 1310 also includes an aldehyde apparatus 1354 with the ketoacid stream 1314 for an input, and a reduced aldehyde ketoacid stream 1356 for an outlet. The unit 1310 also includes a dewatering apparatus 1358 with the reduced aldehyde ketoacid stream 1356 for an inlet, and a dewatered ketoacid stream 1360 and optionally a water stream 1374 for outlets. The unit 1310 also includes a decarboxylation apparatus 1312 with the dewatered ketoacid stream 1360 and a recycle acid stream 1338 for inlets, and a ketone stream 1316 for an outlet. The unit 1310 also includes a first separation apparatus 1334 with the ketone stream 1316 for an inlet, and a carbon dioxide stream 1336, the recycle acid stream 1338, a first separation apparatus effluent stream 1340, and optionally a ketone product stream 1380 for outlets.

The unit 1310 also includes a hydrogenation apparatus 1318 with the first separation apparatus effluent stream 1340, a hydrogen stream 1320, a recycle hydrogen stream 1344, and a recycle ketone stream 1346 for inlets, and an alcohol stream 1322 for an outlet. The unit 1310 also includes a second separation apparatus 1342 with the alcohol stream 1322 for an inlet, and the recycle hydrogen stream 1344, the recycle ketone stream 1346, and a second separation apparatus effluent stream 1370 for outlets. The unit 1310 also includes a dewatering apparatus 1350 with the second separation apparatus effluent stream 1370 for an inlet, and a dewatered alcohol stream 1352, a water stream 1372, and/or a product alcohol stream 1348 for outlets. The product alcohol stream 1348 may be sent to storage, additional processing, and/or the like. The unit 1310 also includes a dehydration apparatus 1324 with the dewatered alcohol stream 1352 and optionally an olefin stream 1382 for inlets, and a water stream 1378, an ether stream 1326 and/or an olefin stream 1328 for outlets.

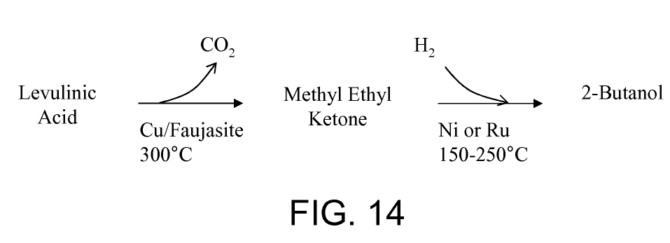

FIG. 14 illustrates a chemical reaction for producing renewable materials, according to one embodiment.

According to one embodiment, the invention may include a unit for producing renewable materials. The unit may include a decarboxylation apparatus for converting a ketoacid stream into a ketone stream, and a hydrogenation apparatus for converting the ketone stream and a hydrogen stream into an alcohol stream.

Unit broadly refers to a piece or complex of apparatuses serving to perform one or more particular purposes or outcomes. Units may include pipes, pumps, valves, vessels, reactors, columns, any other suitable pieces of process equipment, and/or the like. For the sake of nomenclature used herein, a unit generally refers to a collection of one or more apparatuses.

Process equipment broadly refers to any suitable devices and/or items utilizing mechanical principles, thermal principles, chemical principles, and/or the like.

Stream broadly refers to an unbroken flow, such as steady supply of a solid, a liquid, a gas, and/or the like. In some embodiments, streams may flow intermittently and/or in a batchwise manner in addition to a continuous manner. For the sake of nomenclature used herein, a stream generally refers to a flow and/or a connection from a source and/or point, such as between a first apparatus and a second apparatus.

Apparatus broadly refers to a set of materials and/or equipment designed for one or more particular uses. Apparatuses may include pipes, pumps, valves, vessels, reactors, columns, any other suitable pieces of process equipment, and/or the like. For the sake of nomenclature used herein, generally one or more apparatuses may form and/or make a unit.

Renewable material broadly refers to a substance or item that has been at least partially derived from a source or process capable of being replaced by natural ecological cycles or resources. Renewable materials may broadly include chemicals, chemical intermediates, solvents, monomers, oligomers, polymers, biofuels, biofuel intermediates, biogasoline, biogasoline blendstocks, biodiesel, biodiesel blend stocks, biodistillates, and/or the like. Desirably, but not necessarily, the renewable material may be derived from a living organism, such as plants, animals, algae, bacteria, fungi, and/or the like.

Biofuel broadly refers to components or streams suitable for use as a fuel or a combustion source derived from renewable sources, such as may be sustainably produced and/or have reduced or no net carbon emissions to the atmosphere. Renewable resources may exclude materials mined or drilled, such as from the underground. Desirably, renewable resources may include single cell organisms, multicell organisms, plants, fungi, bacteria, algae, cultivated crops, non-cultivated crops, timber, and/or the like.

Biogasoline broadly refers to components or streams suitable for direct use and/or blending into the gasoline or octane pool or supply derived from renewable sources, such as methane, hydrogen, syn (synthesis) gas, methanol, ethanol, propanol, butanol, dimethyl ether, methyl tert buyl ether, ethyl tert butyl ether, hexanol, aliphatic compounds (straight, branched, and/or cyclic), heptane, isooctane, cyclopentane, aromatic compounds, ethyl benzene, and/or the like. Butanol broadly refers to products and derivatives of 1-butanol, 2-butanol, iso-butanol, other isomers, and/or the like. Biogasoline may be used in spark ignition engines, such as automobile gasoline internal combustion engines. According to one embodiment, the biogasoline and/or biogasoline blends meet or comply with industrially accepted fuel standards.

Biodiesel broadly refers to components or streams suitable for direct use and/or blending into the diesel or cetane pool or supply derived from renewable sources, such as fatty acid esters, triglycerides, lipids, fatty alcohols, alkanes, naphthas, distillate range materials, paraffinic materials, aromatic materials, aliphatic compounds (straight, branched, and/or cyclic), and/or the like. Biodiesel may be used in compression engines, such as automotive diesel internal combustion engines. In the alternative, the biodiesel may also be used in gas turbines, heaters, boilers, and/or the like. According to one embodiment, the biodiesel and/or biodiesel blends meet or comply with industrially accepted fuel standards.

Biodistillate broadly refers to components or streams suitable for direct use and/or blending into aviation fuels (jet), lubricant base stocks, kerosene fuels, and/or the like derived from renewable sources, and having a boiling point range of between about 100 degrees Celsius and about 700 degrees Celsius, between about 150 degrees Celsius and about 350 degrees Celsius, and/or the like. According to one embodiment, the biodistillates can be used for fuel or power in a homogeneous charge compression ignition (HCCI) engine. HCCI engines may include a form of internal combustion with well-mixed fuel and oxidizer (typically air) compressed to the point of auto-ignition.

Decarboxylation broadly refers to a chemical reaction in which a carboxyl group (—COOH) cleaves off from a compound, such as to produce carbon dioxide (CO₂) and a remnant of the compound.

Ketoacid broadly refers to organic acids containing a ketone functional group and a carboxylic acid group, such as alpha-keto acids, beta-keto acids, gamma-keto acids, and/or the like.

Ketone broadly refers to compounds which contain a carbonyl group (C═O) bonded to two other carbon atoms.

The decarboxylation apparatus may convert any suitable amount of the ketoacid to a ketone, such as at least about 30 mole percent, at least about 50 mole percent, at least about 70 mole percent, at least about 90 mole percent, at least about 95 mole percent, and/or the like.

According to one embodiment, the unit produces a ketone stream, such as for use as a fuel component, a solvent, a chemical, and/or the like.

Hydrogenation broadly refers to a chemical reaction from the addition of hydrogen (H₂), such as to reduce and/or saturate organic compounds.

The hydrogenation apparatus may convert any suitable amount of the ketone into an alcohol, such as at least about 30 mole percent, at least about 50 mole percent, at least about 70 mole percent, at least about 90 mole percent, at least about 95 mole percent, and/or the like.

Alcohol broadly refers to organic compounds in which a hydroxyl group (—OH) is bound to a carbon atom of an alkyl and/or substituted alkyl group.

The unit may include any suitable efficiency, such as at least 0.3 moles of renewable material for each mole of feedstock, at least about 0.5 moles of renewable material for each mole of feedstock, at least about 0.7 moles of renewable material for each mole of feedstock, at least about 0.9 moles of feedstock for each mole of feedstock, at least about 0.95 moles of feedstock for each mole of feedstock, and/or the like.

According to one embodiment, the ketoacid stream includes levulinic acid, the ketone stream includes methyl ethyl ketone, and the alcohol stream includes butanol.

The unit may also include a dehydration apparatus for converting the alcohol stream into an ether stream and/or an olefin stream, according to one embodiment. A mixed stream of ether and olefin may be produced by the dehydration apparatus.

Dehydration broadly refers to a chemical reaction with the loss of water from the reacting molecule, such as conversion of alcohols into ethers, conversion of alcohols into olefins, and/or the like.

Ethers broadly refer organic compounds with an ether group, such as an oxygen atom connected to two (substituted) alkyl and/or aryl groups.

Olefins broadly refer to unsaturated chemical compounds containing at least one carbon-to-carbon double bond.

According to one embodiment, the ether stream includes dibutylether and the olefin stream includes butylene and/or any suitable isomers.

The unit may also include a hydrolysis apparatus for converting a cellulose stream into the ketoacid stream, according to one embodiment.

Hydrolysis broadly refers to the chemical reaction of a compound with water. Hydrolysis may be used to break down certain polymers, such as cellulose and/or hemicellulose.

Cellulose broadly refers to an organic crystalline polymeric compound with the formula (C₆H₁₀O₅)ₙ, such as a polysaccharide including a linear chain of several hundred to over ten thousand glucose and/or hexose units.

Hemicellulose broadly refers to an organic amorphous polymeric compound, such as including hundreds to thousands of xylose, hexose, and/or pentose units.

According to one embodiment, the hydrogen stream includes hydrogen from decomposition of a portion of the ketoacid stream. The decomposition may be thermal, catalytic, and/or the like. The decomposition may be in-situ within a portion of the unit and/or in a separate process vessel. The hydrogen may be from decomposition of formic acid, such as made in the hydrolysis apparatus.

The unit may further include a first separation apparatus for separating the ketone stream, a carbon dioxide stream, and a recycle acid stream, according to one embodiment. The first separation apparatus may include any suitable process equipment, such as flash drums, columns, trays, packing, pumps, piping, and/or the like. The first separation apparatus may include one flash drum, for example. The feed to the first separation unit may include the effluent from the decarboxylation apparatus.

The unit may further include a second separation apparatus for separating the alcohol stream, a recycle hydrogen steam, and a recycle ketone stream, according to one embodiment. The second separation apparatus may include any suitable process equipment, such as flash drums, columns, trays, packing, pumps, piping, and/or the like. The second separation apparatus may include two flash drums, for example. The feed to the second separation unit may include the effluent from the hydrogenation apparatus.

According to one embodiment, the unit may include a dewatering apparatus for removing water from the alcohol steam. The dewatering apparatus may include a distillation column, a molecular sieve drying system, any suitable process equipment, and/or the like. The dewatered alcohol stream may include any suitable amount of water, such as less than about 1,000 parts per million by mole, less than about 500 parts million by mole, less than about 100 parts per million by mole, less than about 10 parts per million by mole, and/or the like.

According to one embodiment, the unit may include an aldehyde apparatus for removing aldehydes from the ketoacid stream. One potential aldehyde in the feed includes furfural, for example. The aldehyde apparatus may include a distillation column, a reactor, any suitable process equipment, and/or the like. The reduced aldehyde ketoacid stream may include any suitable amount of aldehyde, such as less than about 1,000 parts per million by mole, less than about 500 parts million by mole, less than about 100 parts per million by mole, less than about 10 parts per million by mole, and/or the like. Furfural may also be converted advantageously in the aldehyde unit to additional levulinic acid.

The aldehyde apparatus can include the capabilities to convert the aldehyde to additional ketoacid, such as by a two stage process with hydrogenation and hydrolysis. The hydrogenation may be with a suitable catalyst, such as with group VIII metals and/or the like. The hydrogenation may be at any suitable conditions, such as mild conditions of between about 50 degrees Celsius and about 250 degrees Celsius, and between about 0 kilopascals gauge and about 3500 kilopascals gauge. The hydrolysis may be with a suitable catalyst, such as an acid catalyst. The acid catalyst may include liquid acids, strong acid ion-exchange resins, and/or the like. According to one embodiment, furfural converts to levulinic acid in the aldehyde apparatus.

Aldehyde broadly refers to organic compounds containing a terminal carbonyl group, such as a carbon atom bonded to a hydrogen atom and double-bonded to an oxygen atom (O═CH—).

According to one embodiment, the unit may include a dewatering apparatus for removing water from the ketoacid stream. The dewatering apparatus may include a distillation column, a molecular sieve drying system, any suitable process equipment, and/or the like. The dewatered ketoacid stream may include any suitable amount of water, such as less than about 1,000 parts per million by mole, less than about 500 parts million by mole, less than about 100 parts per million by mole, less than about 10 parts per million by mole, and/or the like.

The decarboxylation apparatus and the hydrogenation apparatus may include a single reactor with multiple catalyst beds, a mixed catalyst bed, a catalyst bed with a multifunctional catalyst, and/or the like, according to one embodiment.

According to one embodiment, the renewable materials made by the unit may include biogasoline materials, biodiesel materials, biodistillate materials, and/or the like.

According to one embodiment, this invention may include a renewable material made in and/or by any of the units described herein.

According to one embodiment, this invention may include a method for producing renewable materials. The method may include the step of converting a ketoacid stream into a ketone stream in a decarboxylation apparatus, and the step of converting the ketone stream and a hydrogen stream into an alcohol stream in a hydrogenation apparatus.

The ketoacid stream may include levulinic acid, the ketone stream may include methyl ethyl ketone, and the alcohol stream may include butanol, according to one embodiment.

The method may also include the step of converting the alcohol stream into an ether stream and/or an olefin stream in a dehydration apparatus, according to one embodiment. The ether stream may include dibutylether and the olefin stream may include butylene.

According to one embodiment, the method may also include the step of converting a cellulose stream into the ketoacid stream in a hydrolysis apparatus.

According to one embodiment, the method may also include the step of decomposing a portion of the ketoacid steam for the hydrogen stream.

The step of decomposing may occur in situ within a portion of a unit for producing renewable materials, in a separate piece of process equipment, and/or the like.

According to one embodiment, the method may further include the step of separating the ketone stream, a carbon dioxide stream, and a recycle acid stream in a first separation apparatus, and the step of separating the alcohol stream, a recycle hydrogen steam, and a recycle ketone stream in a second separation apparatus.

Optionally and/or additionally, the method may include the step of removing water from the alcohol steam in a dewatering apparatus.

Optionally and/or additionally, the method may include the step of removing aldehydes from the ketoacid stream in an aldehyde apparatus.

Optionally and/or additionally, the method may include the step of removing water from the ketoacid stream in a dewatering apparatus.

According to one embodiment, the method may include a single reactor for both the decarboxylation apparatus and the hydrogenation apparatus. The single reactor may include multiple catalyst beds, a mixed catalyst bed, a catalyst bed with a multifunctional catalyst, and/or the like.

According to one embodiment, the renewable materials made by the method may include biogasoline materials, biodiesel materials, biodistillate materials, and/or the like.

According to one embodiment, the invention may include a renewable material made in and/or by any of the methods described herein.

As used herein the terms “having”, “comprising”, and “including” are open and inclusive expressions. Alternately, the term “consisting” is a closed and exclusive expression. Should any ambiguity exist in construing any term in the claims or the specification, the intent of the drafter is toward open and inclusive expressions.

Regarding an order, number, sequence and/or limit of repetition for steps in a method or process, the drafter intends no implied order, number, sequence and/or limit of repetition for the steps to the scope of the invention, unless explicitly provided.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A unit for producing renewable materials, the unit comprising:
a decarboxylation apparatus for converting a ketoacid stream into a ketone stream; and
a hydrogenation apparatus for converting the ketone stream and a hydrogen stream into an alcohol stream.

2. The unit of claim 1, wherein:
the ketoacid stream comprises levulinic acid;
the ketone stream comprises methyl ethyl ketone; and
the alcohol stream comprises butanol.

3. The unit of claim 1, further comprising a dehydration apparatus for converting the alcohol stream into an ether stream or an olefin stream.

4. The unit of claim 3, wherein the ether stream comprises dibutylether and the olefin stream comprises butylene.

5. The unit of claim 1, further comprising a hydrolysis apparatus for converting a cellulose stream into the ketoacid stream.

6. The unit of claim 5, wherein the hydrogen stream comprises hydrogen from decomposition of a portion of the ketoacid stream.

7. The unit of claim 6, wherein the decomposition occurs in-situ within a portion of the unit.

8. The unit of claim 1, further comprising:
a first separation apparatus for separating the ketone stream, a carbon dioxide stream, and a recycle acid stream; and
a second separation apparatus for separating the alcohol stream, a recycle hydrogen steam, and a recycle ketone stream.

9. The unit of claim 1, further comprising a dewatering apparatus for removing water from the alcohol steam.

10. The unit of claim 1, further comprising an aldehyde apparatus for removing aldehydes from the ketoacid stream.

11. The unit of claim 1, further comprising a dewatering apparatus for removing water from the ketoacid stream.

12. The unit of claim 1, wherein the decarboxylation apparatus and the hydrogenation apparatus comprise a single reactor with multiple catalyst beds, a mixed catalyst bed, or a catalyst bed with a multifunctional catalyst.

13. The unit of claim 1, wherein the renewable materials comprise biogasoline materials, biodiesel materials, or biodistillate materials.

14. A renewable material made in the unit of claim 1.

15. A method for producing renewable materials, the method comprising:
converting a ketoacid stream into a ketone stream in a decarboxylation apparatus; and
converting the ketone stream and a hydrogen stream into an alcohol stream in a hydrogenation apparatus.

16. The method of claim 15, wherein:
the ketoacid stream comprises levulinic acid;
the ketone stream comprises methyl ethyl ketone; and
the alcohol stream comprises butanol.

17. The method of claim 15, further comprising converting the alcohol stream into an ether stream or an olefin stream in a dehydration apparatus.

18. The method of claim 17, wherein the ether stream comprises dibutylether and the olefin stream comprises butylene.

19. The method of claim 15, further comprising converting a cellulose stream into the ketoacid stream in a hydrolysis apparatus.

20. The method of claim 19, further comprising decomposing a portion of the ketoacid steam for the hydrogen stream.

21. The method of claim 20, wherein the decomposing occurs in-situ within a portion of a unit for producing renewable materials.

22. The method of claim 15, further comprising:
separating the ketone stream, a carbon dioxide stream, and a recycle acid stream in a first separation apparatus; and
separating the alcohol stream, a recycle hydrogen steam, and a recycle ketone stream in a second separation apparatus.

23. The method of claim 15, further comprising removing water from the alcohol steam in a dewatering apparatus.

24. The method of claim 15, further comprising:
removing aldehydes from the ketoacid stream in an aldehyde apparatus.

25. The method of claim 15, further comprising removing water from the ketoacid stream in a dewatering apparatus.

26. The method of claim 15, wherein the decarboxylation apparatus and the hydrogenation apparatus comprise a single reactor with multiple catalyst beds, a mixed catalyst bed, or a catalyst bed with a multifunctional catalyst.

27. The method of claim 15, wherein the renewable materials comprise biogasoline materials, biodiesel materials, or biodistillate materials.

28. A renewable material made by the method claim 15.
